(19) United States
(12) Patent Application Publication
(10) Pub. No.: US 2023/0234177 A1
(43) Pub. Date: Jul. 27, 2023

(54) MACHINE TOOL AND METHOD FOR MACHINING WORKPIECES

(71) Applicant: HUGO RECKERTH GMBH, Filderstadt-Bonlanden (DE)

(72) Inventors: Alexander Dobrinski, Stuttgart (DE); Michael Böhm, Filderstadt-Bonlanden (DE); Anatolii Hushchyn, Kramatorsk (UA)

(21) Appl. No.: 18/010,782

(22) PCT Filed: Jun. 11, 2021
(86) PCT No.: PCT/EP2021/065783

§ 371 Date: Dec. 15, 2022

(30) Foreign Application Priority Data
Jun. 16, 2020 (DE) 10 2020 115 858.0

(51) Int. Cl. B23Q 5/32

(52) U.S. Cl. CPC B23Q 5/326; B23Q 5/323

(57) ABSTRACT

A machine tool (10) for machining workpieces (18) has a main spindle (12) which carries a tool holder (14) at its end and is mounted in such a way that it can rotate about an axis of rotation (22) and can move along the axis of rotation (22). A preferably electromagnetic feed device (32) is also provided, which exerts a force (FZ) acting along the axis of rotation s on the main spindle (12). A screw gear (52), which connects a drive (20) for driving the main spindle to the main spindle (12), drives the main spindle (12) in rotation and simultaneously moves it along the axis of rotation (22). The screw-and-nut gearing (52) has a thread (64, 66a, 66b) formed on a first component (54) and a cam (70a, 70b) formed on a second component (12) that cooperates with the thread (64, 66a, 66b). One of the two components (54) is rotated by the drive (20) via a drive gear (57) and is immovably mounted along the axis of rotation (22). The other of the two components is the main spindle (12).

### BACKGROUND OF THE INVENTION

### 1. Field of the Invention

The invention relates to a machine tool and a method for machining workpieces, in which a main spindle is moved along a preferably vertical feed direction with the aid of a preferably electromagnetic feed device. Such machine tools are mainly used for drilling, grinding or milling.

### 2. Description of the Prior Art

When drilling, grinding and milling workpieces using machine tools, the achievable surface quality and process reliability depend, among other things, on the materials from which the workpieces to be machined are made. When machining brittle materials such as glass, stone, ceramics, ferrite, gemstones or polycrystalline diamonds (PCD), cracks or chipping often occur, resulting in the rejection of the workpiece. Machining of materials with inhomogeneous and/or anisotropic properties is also difficult, including fiber composites with the subgroup of fiber-reinforced plastics (for example CFRP or PCB) and multi-material composites as well as stacks (CFRP-metal layered composites). With these materials, the effectiveness of machining often leaves much to be desired, although the machining quality is low and the tools used wear out or are damaged quickly.

With the aforementioned problematic materials, the entry zone and the exit zone of the tool on the workpiece are particularly critical. This is especially true if the surface of the workpiece is not aligned perpendicular to the feed direction of the tool. Demanding machining tasks, such as providing an inclined glass plate with a fine bore, cannot be satisfactorily solved with the known machine tools up to now.

The cause of these difficulties is usually not the poor quality of the tools used, but a lack of or inadequate coordination of the cutting forces occurring during machining. Cracks, chipping, burr formation, delamination (in the case of CFRP composites) or other damage to the workpieces usually occur when the torques and/or axial forces acting between the tool and the workpiece are too great. Remarkably, damage to the workpieces occasionally occurs even if the torques and axial feed forces generated by the drives of the machine tool are selected to be very small. Inclusions and other inhomogeneities in the workpiece can cause very high torques or forces to act on the workpiece and/or the tool for a short time and cause damage there.

DE 27 47 516 A1 describes a machine tool in which the drilling pressure exerted by the main spindle is monitored by a sensor system in order to prevent damage to the drill and the main spindle.

DE 20 2016 102 124 U1 discloses a machine tool whose main spindle can be moved along the feed direction with the aid of an electromagnetic feed device. The electromagnetic feed device comprises two ring coil magnets, which are arranged on both sides of a disk armature attached to the main spindle. By controlling the ring coil magnets, the main spindle can be moved in the axial direction. In particular, this allows the entry speed of the tool into the workpiece to be reduced in such a way that breakage of sensitive workpieces can be avoided. The feed motion of the main spindle can also be superimposed with micro-vibration movements, which lead to better machining results.

Although the use of such an electromagnetic feed device to feed the main spindle leads to a noticeable improvement in the machining of problematic materials, the associated problems have still not been completely solved. Workpieces made of problematic materials are still too frequently damaged, especially when they are thin and/or are arranged at an angle to the feed direction. Even in the absence of damage leading to scrap, the machining quality usually falls well short of expectations.

### SUMMARY OF THE INVENTION

It is the object of the invention to provide a machine tool and a method for the machining of workpieces which achieves better machining results also for workpieces which are difficult to machine by drilling, milling or grinding due to their material properties and/or their shape.

According to the invention, this object is achieved with regard to the machine tool by a machine tool for the machining of workpieces, which has a main spindle, which carries a tool holder at the end and is mounted so as to be rotatable about an axis of rotation and movable along the axis of rotation. The machine tool also has a drive for driving the main spindle about the axis of rotation and a preferably electromagnetic feed device configured to exert on the main spindle a force acting along the axis of rotation. According to the invention, the machine tool comprises a screw-and-nut gearing connecting the drive to the main spindle and configured to rotate the main spindle and simultaneously move it along the axis of rotation. The screw-and-nut gearing has a thread formed on a first component and a cam formed on a second component which cooperates with the thread. One of the two components is rotatable by the drive via a drive gear and is immovably mounted along the axis of rotation. The other of the two components is the main spindle.

The screw-and-nut gearing acts as a limiting device which effectively limits the axial and tangential forces and the torques generated during machining. The invention is based on the conception that limiting these forces and torques with the aid of sensors is not only very costly, but damage to the workpiece and the tool and other quality defects cannot be reliably prevented in this way due to the unavoidable inertia of the controls used. If, for example, the torque increases briefly due to an inhomogeneity in the workpiece, sensor-based control systems cause a reduction in the power of the drive for the main spindle. Due to the inertia of the main spindle, however, the torque does not drop immediately, but continues to act for a short period, which is sufficient to cause damage to the workpiece or the tool. Safety clutches can effectively limit the torque that occurs. The release of a safety clutch can prevent damage to the workpiece or the tool, but it interrupts the machining process and therefore contributes little to a better machining result.

As is well known, a screw-and-nut gearing is based on the principle of the inclined plane. If a machine screw is screwed into a nut from below, the screw can be set in rotation if the nut is set in rotation around the axis of symmetry of the screw against the pitch of the screw thread. The nut then “pushes” the screw via the rising thread. If the rotation of the screw is made more difficult by increasing a resistance, the screw is pulled into the nut from a certain combination of axial resistance force and resistance torque.

The screw-and-nut gearing of the machine tool according to the invention functions according to the same principle. However, the feed device can additionally generate an axial force acting along the axis of rotation, as a result of which not only is the screw set in rotation when the nut is rotated in the above example, but the screw also turns out of the nut when the nut is set in rotation. If the workpiece offers great resistance to the tool during penetration, the main spindle with the tool attached to it automatically withdraws from the workpiece with practically no delay, thus leaving the cutting zone where damage to the workpiece or tool can occur. This immediately reduces the resistance that the workpiece exerts on the tool. The tool spindle with the tool attached to it thus quickly changes its direction of movement again and moves back towards the workpiece. When greater resistance is encountered during machining, the main spindle thus performs axial oscillations that have proven beneficial for the machining result and in particular for the phase in which the tool enters or exits the workpiece.

The resistance at which the tool withdraws from the workpiece can be set by the force acting along the axis of rotation, which is generated by the feed device. The greater this force, the greater must be the resistance experienced by the tool in the workpiece to cause the tool to be withdrawn from the workpiece by means of the screw-and-nut gearing. In general, the axial force generated by the feed device will therefore have to be adapted to the specific machining operation. In principle, it would also be possible to alternatively or additionally adapt the torque provided by the drive to the specific machining task or the momentary machining phase of the drilling operation. Since the torque of the electric motors typically used is often approximately proportional to the current, the torque can be relatively well defined via a suitable current control. In general, however, the drives are controlled in such a way that a predetermined speed is to be achieved, since this is also significant for the machining result. It is therefore preferable if only the axial force exerted by the feed device is used as a variable parameter that can be adapted to the specific machining task.

The direction of the axial movement of the main spindle along the axis of rotation depends primarily on the magnitude of the force generated by the feed device, the torque generated by the drive, the resistance force acting along the axis of rotation that a tool received in the tool holder experiences in the workpiece, and the resistance torque that the tool experiences in the workpiece with respect to a rotation about the axis of rotation.

Tests with the machine tool according to the invention have shown that excellent machining results can be achieved even with the most difficult drilling tasks, for example the drilling of fine holes in thin inclined glass plates, without the otherwise occurring difficulties such as chipping, fractures or other damage to the workpiece and tool.

In principle, the screw-and-nut gearing can be designed like a conventional spindle-and-thread drive. In this case, the main spindle can carry an external thread which supports a sleeve with a corresponding internal thread. The sleeve is axially fixed and rotatable about the axis of rotation and is set in rotation about the axis of rotation of the main spindle by a drive of the machine tool via the drive gear. To reduce friction between the gear components, a ball screw can be used instead of a simple spindle-thread drive.

However, it has been shown that the threads of conventional spindle-thread drives cannot easily withstand the high loads that occur during machining with machine tools. A more robust screw-and-nut gearing is therefore preferred, in which the first component has a sleeve whose wall has a helical recess on the inside, which is bounded by two helical surfaces that are preferably parallel to one another. This recess can be engaged either by a cam in the form of a complementarily shaped counterpart formed on the second component. Preferably, however, the cam formed on the second component has a radially projecting pin which engages in the helical recess. The pin is guided with slight play in the recess so that it bears against one of the two helical surfaces depending on the axial direction of movement of the main spindle. The sleeve, which is rotated by the drive via the drive gear, then uses one of the two helical surfaces to transmit the forces and torques required for machining to the pin and thus to the main spindle.

Instead of a recess, the sleeve may also have an aperture.

To reduce friction between the pin and the helical surfaces, the pin may carry a roller that engages one of the helical surfaces. Sliding shoes can also be used instead of rollers.

For symmetry, the second component preferably has not one but two or more radially projecting pins. When two pins are diametrically opposed, the thread formed on the first component must be multi-start. However, the pins can also be arranged at a distance from each other in the axial direction without this leading to uncontrollable bearing loads due to the unequal centrifugal forces.

In most cases, it will be most favorable if the thread is not formed on the main spindle but on the other component. In principle, however, it is also possible to drive a component via the drive thread, which drives the main spindle, which is provided with an external thread, via the cam.

In one embodiment, the feed device is electromagnetic and has a stator fixed to the housing and a rotor mounted for movement along the axis of rotation, which transmits its axial movements to the main spindle.

The rotor can be positioned in an axial rest position by a first electromagnet. A second electromagnet is arranged in the stator, which can be used to generate a feed force directed toward the workpiece holder. A feed device designed in this way is advantageous because the first electromagnet carries the weight force of the main spindle and the tool attached to it. The feed movement can then be controlled exclusively with the aid of the second electromagnet without having to reverse its polarity for this purpose. In this design example, the first electromagnet generates a restoring force against whose resistance the second electromagnet presses the main spindle towards the workpiece. To raise the tool spindle again, only the force applied by the second electromagnet and acting towards the workpiece must be reduced to such an extent that the restoring force generated by the first electromagnet prevails.

The electromagnets can comprise several sections, which are supplied by independent current sources. This allows the feed force to be set even more precisely.

The windings of the electromagnets can, for example, be made of copper, aluminum or alloys containing at least one of these metals.

The advantage that the polarity does not have to be reversed when changing direction, thus avoiding losses due to oscillation, is particularly significant if the machine tool has a manual or programmable control device which is set up to control the feed device in such a way that, at least in a period after the tool has penetrated the workpiece, the tool advances into the workpiece with a feed motion to which oscillations are superimposed. In order to generate such oscillations, in conventional electromagnetically operated feed devices the electromagnet must be reversed in polarity at the frequency of the desired oscillation, which inevitably leads to hysteresis losses, to changes in the feed force and thus to unnecessary energy consumption and to undesirable heat generation.

Instead of an electromagnetic feed device, a hydraulic or screw-type feed device can also be used. With electromagnetic feed devices, however, the feed can be controlled particularly precisely.

With regard to the method, the task formulated above is solved by a method for machining workpieces, which comprises the following steps:
a) driving a main spindle, which carries at its end a tool holder with a tool inserted therein, so that the tool spindle rotates about an axis of rotation;
b) exerting a force acting along the axis of rotation on the main spindle with the aid of a feed device.

According to the invention, the main spindle is caused to rotate by means of a screw-and-nut gearing connecting a drive to the main spindle, and is simultaneously moved along the axis of rotation.

With regard to the advantages associated with the process according to the invention and the further advantageous design of the process, reference is made to the above explanations on the machine tool, which apply accordingly.

### SHORT DESCRIPTION OF THE DRAWINGS

In the following, an embodiment of the invention is explained in more detail with reference to the drawings. In these show:

FIG. 1a: a schematic axial section through essential parts of a machine tool according to an embodiment of the invention in a first feed position of the main spindle before the start of machining;

FIG. 1b: a schematic axial section as shown in FIG. 1a, but with the main spindle in a second feed position during machining;

FIG. 2: A perspective view of a section of the main spindle of the machine tool shown in FIGS. 1a and 1b;

FIG. 3: A perspective view of the screw drive of the machine tool shown in FIGS. 1a and 1b;

FIG. 4: a cross-section through the screw-and-nut gearing unit shown in FIG. 3;

FIGS. 5a and 5b: schematic diagrams of an inclined plane to explain the principle of operation of the screw drive;

FIG. 6: A current-time diagram to explain a possible control of the electromagnetic feed device.

### DESCRIPTION OF PREFERRED EMBODIMENTS

### 1. Structural Design

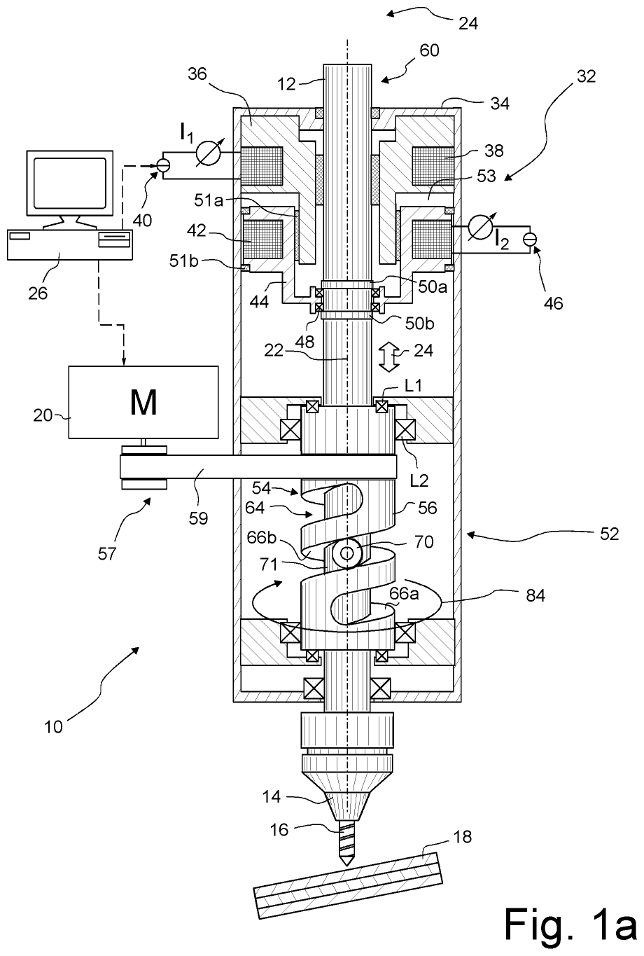

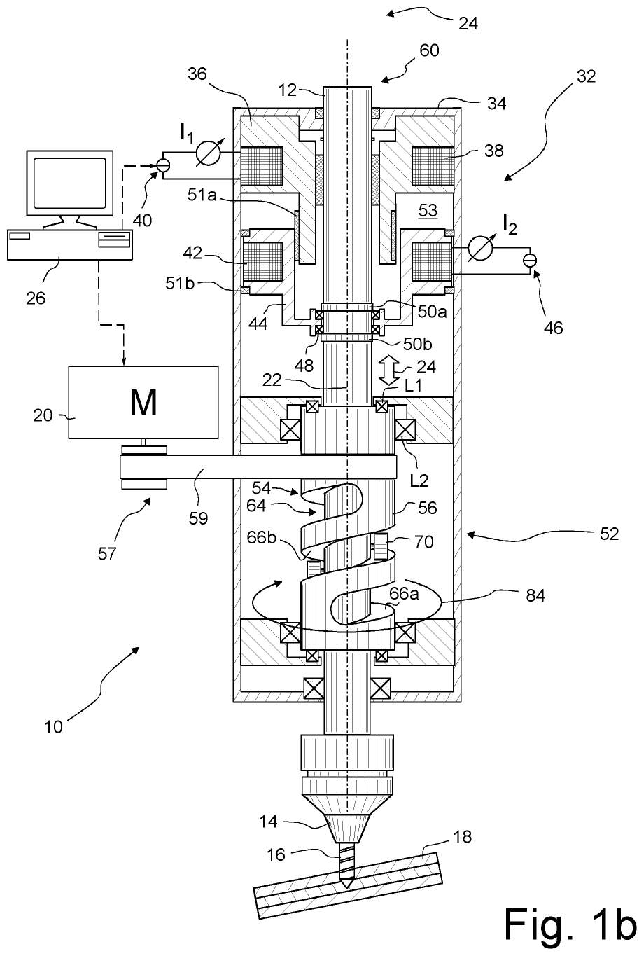

FIG. 1a shows in schematic section important parts of an embodiment of a machine tool according to the invention and designated in its entirety with 10.

The machine tool 10 has a main spindle 12, which carries a tool holder 14 at its end. A tool 16, which in the present embodiment is a twist drill, can be clamped in the tool holder 14 in a manner not shown in greater detail. Instead of a twist drill, for example, a countersink, a reamer, a cylindrical milling cutter, a diamond drill or a special drilling tool can also be secured to the main spindle 12, as is known per se in the prior art. Also shown in FIG. 1 is a workpiece 18 into which the tool 16 has penetrated. The workpiece 18 in this case is an inclined composite plate consisting of several plate-like materials.

The main spindle 12 is mounted so as to be rotatable about an axis of rotation 22 and also movable along the axis of rotation 22, as indicated by a double arrow 24. The direction indicated by the double arrow 24 is hereinafter referred to as the feed direction.

In order to move the main spindle 12 along the feed direction 24, the machine tool 10 has a feed device 32, the structure of which is shown in simplified form in FIG. 1a. The feed device 32 is accommodated in a housing 34 of the machine tool and comprises a stator 36 with a stator winding 38, which is connected to a controllable current source 40. This in turn is controlled by a control device 26, which is indicated in FIG. 1a as a personal computer (PC). In addition, the feed device 32 comprises a rotor winding 42 which is accommodated in an axially movably mounted rotor 44. In the embodiment shown, the rotor winding 42 is connected to a constant current source 46 and therefore generates a magnetic field which is constant with time and whose strength depends on the current 12 generated by the constant current source 46. The rotor 44 engages two collars 50a, 50b projecting radially from the main spindle 12 via ball bearings 48, causing the main spindle 12 to follow axial movements of the rotor 44. The ball bearings 48 decouple the rotational movement of the main spindle 12 from the rotor 44, which therefore only performs movements in the axial direction, but is not rotated. In the axial direction, the rotor 44 is guided by plain bearings 51a, 51b relative to the stator 36 or the housing 34. The movements of the rotor 44 and the main spindle 12 carried thereby can be seen in FIG. 1b, in which the machine tool 12 is shown after the main spindle 12 has been lowered.

The stator 36 and the housing 34 are at least partially made of a material that conducts magnetic flux well. Suitable materials include, for example, alloys containing iron and/or nickel such as PERMENORM 5000 H3 or other soft magnetic materials, e.g. steel C10 or steel C15 with low carbon content.

During machine tool operation, the rotor winding 42 generates magnetic flux in the core of the stator 36 that must bridge an air gap 53 remaining between the stator 36 and the rotor 44. The magnetic flux passes through the interfaces at the air gap 53 and generates an attractive reluctance force that seeks to reduce the size of the air gap 53. The reluctance force is large enough to support the dead weight of the main spindle, the tool holder 14 and the tool 16 attached to it. This is true even if the air gap 53 is increased by lowering the rotor 44, thereby decreasing the reluctance force. Thus, the rotor winding 42 fed by the constant current source 46, together with the surrounding materials ensuring a high magnetic flux, has a kind of reverse spring action in which the restoring force becomes smaller rather than larger with increasing travel, unlike a spring.

In order to lower the rotor 44 together with the main spindle 12 against the reluctance force generated by the rotor winding 42, a current I₁ is applied to the stator winding 38 by means of the controllable current source 40, which generates a magnetic field in the stator winding 38 which is opposed to the magnetic field generated by the rotor winding 42. This creates a repulsive and downward force that increases as the current I₁ increases. If the main spindle 12 is to be raised again, the current I₁ is reduced, which decreases the repulsive effect between the two electromagnets realized by the stator winding 38 and the rotor winding 42. In this way, the main spindle 12 can be lowered and raised along the feed direction 24 without having to reverse the polarity of an electromagnet for this purpose. Unwanted heat generation due to hysteresis losses caused by reversing the polarity can be avoided in this way.

In principle, practically any trajectory of the main spindle 12 along the feed direction 24 can be generated in this way. Even complicated motion sequences, for example the superimposition of a constant axial acceleration with an oscillating motion, are possible. After penetration of the tool 16 into the workpiece 18, the actual trajectory naturally also depends on its properties.

A drive 20 implemented as an electric motor for driving the main spindle 12 about the axis of rotation 22 is connected to the main spindle 12 via a drive gear 57 and a screw-and-nut gearing 52. The screw-and-nut gearing 52 includes a first component 54 having a hollow cylindrical sleeve 56. The first component 54 is arranged in the housing 34 so as to be rotatable about the axis of rotation 22 and axially immovable by means of bearings L1, L2 and encloses the axially movably guided main spindle 12. During operation of the machine tool 10, the sleeve 56 is rotated by the drive 20 via the drive gear 57. In the embodiment shown, the drive gear 57 is designed as a belt drive with a circulating belt 59. Of course, gear boxes or other positive-locking transmission boxes can also be used as drive gears 57.

The sleeve 56 has a wall with a helical aperture 64 bounded by a lower helical surface 66a and an upper helical surface 66b. The sleeve 56 thus resembles a screw, the core of which has been removed and which therefore comprises only the thread as such.

The screw-and-nut gearing 56 also includes, as a second component, the main spindle 12 on which two cams 70 are formed to cooperate with the thread formed on the first component 54. The cams 70a, 70b, of which only the forward facing cam 70a is visible in FIG. 1a, project radially from the main spindle 12 and engage the helical aperture 64 of the sleeve 56.

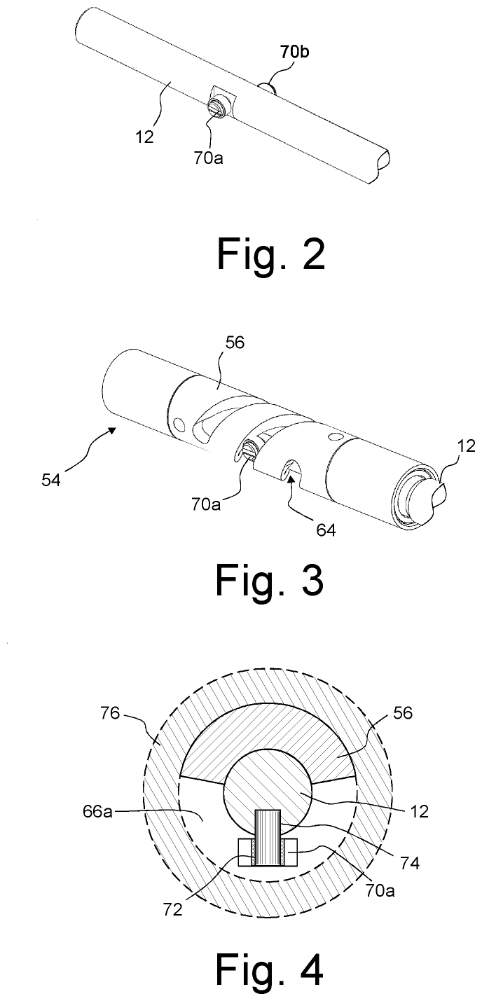

FIG. 2 shows the lower section of the main spindle 12 in a perspective view, in which the two radially projecting and axially offset cams 70a, 70b are clearly visible. FIG. 3 shows the screw-and-nut gearing 52 in a perspective view in the assembled state.

In the cross-section of FIG. 4 through the main spindle 12 at the level of the it can be seen that the cam 70a is formed by a roller which is fitted via a plain bearing 72 onto a pin 74 which is pressed into a radially extending bore 74 in the main spindle 12. This allows the cams 70a, 70b to run with low friction on either the lower helical surface 66a or the upper helical surface 66b of the sleeve 56, depending on the axial load.

In FIG. 4, an optional outer sleeve 76 is indicated by dashed lines, which completely encloses the sleeve 56 and whose wall has no apertures. Such an outer sleeve 76 may be useful to protect the helical surfaces 66a, 66b and the cams 70a, 70b from contamination and to increase the stability of the first component 54.

### 2. Function of the Screw-and-Nut Gearing

When the first component 54 rotates about the longitudinal axis 22, the rotation is transmitted to the main spindle 12 via the cams 70a, 70b. However, the main spindle 12 can also perform axial movements relative to the first component 54 along the feed direction 24 when the cams 70a, 70b run in the helical aperture 64. If the screw-and-nut gearing 52 is designed accordingly, these axial movements of the main spindle 12 can be used to pull the tool 16 out of the workpiece 18 if the resistance between the tool 16 and the workpiece 18 becomes too great.

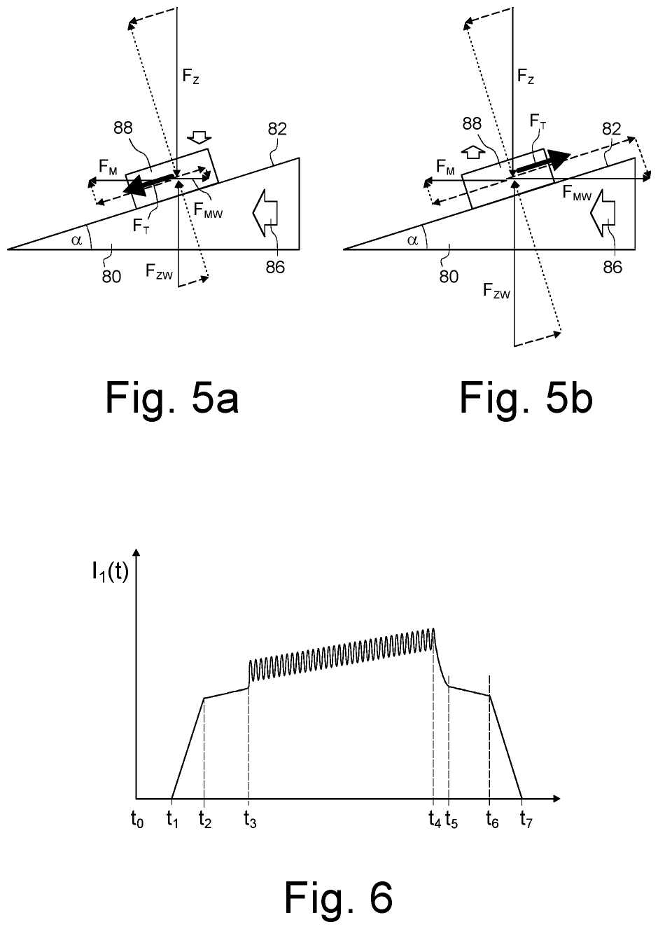

This will be explained below with reference to FIGS. 5a and 5b. The action of the screw-and-nut gearing 52 is based on the principle of the inclined plane. Shown in FIG. 5a is a wedge 80 defining an inclined plane 82, which can be thought of as a section of the sleeve 56 of the first component 54. When the sleeve 56 is rotated by the drive 20 in the direction of rotation indicated by an arrow 84 in FIG. 1a, this corresponds to a movement of the wedge 80 in the direction shown by an arrow 86 in FIG. 5a. One of the cams 70a, 70b is represented in the schematic diagram of FIG. 5a by a cuboid 88 which rests on the inclined plane 82. In the following it is assumed that the friction between the parallelepiped 88 and the inclined plane 82 can be neglected.

On the one hand, the cuboid 88 representing one of the cams 70a, 70b is acted upon by a vertically downwardly acting force F_{Z}, which represents a sum of all forces acting downwardly along the axis of rotation 22 (i.e. toward the workpiece 18). Contributing to this force is, in particular, the weight force of the main spindle and the parts attached thereto (slider 44, tool holder 14 and tool 16) as well as the force generated by the feed device 32 along the feed direction 24.

At the same time, a force F_{ZW} acts in the opposite direction on the cams 70a, 70b or the parallelepiped 88 in FIG. 5a, which is caused by the resistance of the tool 16 in the workpiece 18.

The cams 70a, 70b and the cuboid 88 in FIG. 5a are also subjected to torque, which can be converted into a tangential (i.e. circumferential) force component by taking the lever arm into account. A force component F_{M} is generated by the motor 20, whose torque acts via the drive gear 57 and the sleeve 56 on the cams 70a, 70b or the cuboid 88 in FIG. 5a. In the opposite direction, a tangential force component F_{MW} acts, which is due to a moment of resistance that the workpiece 18 opposes the tool 16 during its rotation about the axis of rotation 22.

If one considers the components of the aforementioned forces acting along the inclined plane 82, as indicated by dashed arrows in FIG. 5a, and sums up these components, the result is a resulting force F_{T} which, in the example case shown in FIG. 5a, points obliquely downward. In this constellation, therefore, a force acts on the cuboid 88 to cause it to slide down the inclined plane 82. Transferred to the screw-and-nut gearing 52, this means that the cams 70a, 70b slide downward on the lower screw surface 66a, causing the main spindle 12 to lower downward. This downward movement is superimposed by the simultaneous rotation of the main spindle 12 about the axis of rotation 22, since the cuboid 88 in FIG. 5a is also carried along by the inclined plane 82 moving along the arrow 86.

FIG. 5b shows the forces discussed above schematically for another configuration. Here it was assumed that the axial resistance force F_{ZW} has increased significantly, for example because the workpiece 18 is particularly hard. This is usually accompanied by a larger section modulus and thus a larger force F_{MW}, which opposes the force F_{M} caused by the drive. In the constellation shown in FIG. 5b, the axial force components approximately cancel each other out. However, the force F_{MW} caused by the resisting torque is significantly greater than the force F_{M} generated by the drive, which means that the resulting force F_{T} now runs diagonally upwards.

Consequently, the cuboid 88 now moves up the inclined plane 82. Applied to the screw-and-nut gearing 52, this means that the cams 70a, 70b move upward in the helical aperture 64, causing the main spindle 12 to move upward. Thus, if the tool 16 experiences a large resistance in the workpiece 18, the main spindle 12 automatically withdraws from the workpiece 18 until the resistance in the workpiece 18 has decreased again to such an extent that the constellation shown in FIG. 5a is present and the main spindle 12 is again forced into a downward movement.

As a rule, these downward and upward movements of the main spindle 12 are repeated throughout the machining process, as a result of which the tool 16 does not penetrate the workpiece 18 at a uniform feed rate, but with a superimposed oscillation. Such oscillation has been found to be very beneficial to machining results and process quality.

Most importantly, however, the screw-and-nut gearing 52 ensures that the resistance experienced by the tool in the workpiece 18 cannot exceed a predetermined level, as the machine tool 10 immediately automatically withdraws the tool 16 from the cutting zone. This reaction is instantaneous and does not require the cooperation of sensors or control circuits, as is known in the prior art.

The resistance, the exceeding of which leads to lifting of the main spindle 12, is composed of the resistance in the axial direction (F_{ZW}) and the resistance (F_{MW}) that the workpiece 18 opposes to the rotation of the tool 16. Therefore, lifting occurs even if, for example, only the axial resistance force F_{ZW} increases to such an extent that the resulting force F_{T} leads to an upward movement. Whether the moment of resistance via the force F_{MW} or the axial force F_{ZW} has the predominant influence depends on the pitch of the thread formed by the aperture 64 in the sleeve 56. This pitch corresponds to the angle α of the wedge 80, which is decisive for the force components acting along the inclined plane 82. If the angle α and thus the pitch of the screw-and-nut gearing 52 is small, the influence of the axial forces recedes in favor of the torques. As the angle α increases, the influence of the axial forces on the behavior of the screw-and-nut gearing 52 increases. The angle α must be selected in such a way that self-locking is avoided.

The force F_{M} due to the motor 20 often cannot be influenced directly, since the control of the motor 20 is usually not aimed at generating a specific torque, but a specific speed. In general, this force F_{M} does not change significantly during machining. However, it is easy to influence the axial and downward force F_{Z}, which can be pre-set by the feed device 32.

The current I₁ generated by the controllable current source is thereby approximately proportional to the force F_{Z} and can thus be used to define the force ratio at which an upward movement of the spindle 12 and thus a brief interruption of machining is triggered.

As is clear from FIGS. 5a and 5b, the downward force F_{Z} always generates a downward component that must be overcome by the resistance of the tool 16 in the workpiece 18 in order for upward movement of the main spindle 12 to occur. Thus, the greater the downward force F_{Z}, the greater the resistance of the tool 16 in the workpiece 18 can become before the main spindle 12 moves upward in a kind of evasive movement. In the case of sensitive workpieces 18 or problematic machining situations, as indicated by the inclined position of the workpiece 18 in FIGS. 1a and 1b, it is therefore advisable to limit the axial force F_{Z} generated by the feed device 32 to a small value in order to prevent damage to the tool 16 or the workpiece 18.

### 3. Superimposition of Additional Oscillations

The oscillations of the tool 16 described above, which are caused by the screw drive 52, can be superimposed by additional oscillations, which are specifically generated by the feed device 32.

FIG. 6 shows an example of a possible control of the stator winding 38 by the controllable current source 40. The current I₁ flowing through the stator winding 38 as a function of the time t is plotted in the graph of FIG. 6.

Between the time t₀ and the time t₁, no current flows through the stator winding 38. The rotor 44 and thus also the main spindle 12 are thus in an upper rest position, as shown in FIG. 1a.

In order to lower the tool 16 in the direction of the workpiece 18, the current is increased linearly in an interval between the times t₁ and t₂, which leads to a uniform lowering of the workpiece 16.

Shortly before the tool 16 hits the workpiece 18, the increase in current I₁ is reduced so that the tool 16 hits the workpiece 18 with the lowest possible feed force. This considerably reduces the risk of the problems mentioned at the outset, such as edge breakage, delamination or tool breakage, occurring during tool entry. As soon as the tool 16 has entered the workpiece 18 (time t₃), the current I₁ increases. At the same time, an oscillation is superimposed on the current I₁, which leads to additional axial upward and downward movements of the tool 16 during the machining process.

After the oscillating feed is completed at time t₄, the current in stator winding 38 is rapidly reduced to time t₅, causing the tool 16 to be raised rapidly. Just before the tool 16 exits the workpiece 18 (time t₅), the feed force and thus the speed along the feed direction 24 is further reduced so that the tool 16 does not cause damage to the surface of the workpiece 18 as it exits the workpiece 18. As soon as at time t₆ the tool 16 is no longer in contact with the workpiece 18, the tool 16 is quickly removed from the workpiece 18 until the initial position has been reached again at time t₇.

1-13. (canceled)

14. A machine tool for machining a workpiece, the machine tool comprising:
a main spindle having an end that carries a tool holder, wherein the main spindle is mounted so as to be rotatable about an axis of rotation and movable along the axis of rotation;
a drive for driving the main spindle about the axis of rotation;
a feed device configured to exert a force on the main spindle, wherein the force acts along the axis of rotation; and
a screw-and-nut gearing connecting the drive to the main spindle and configured to drive the main spindle in rotation and simultaneously move the main spindle along the axis of rotation,
wherein the screw-and-nut gearing comprises a thread formed on a first component and a cam formed on a second component and cooperating with the thread,
wherein one of the first component and the second component is rotatable by the drive via a drive gear and is immovably mounted along the axis of rotation, and
wherein the other one of the first component and the second component is the main spindle.

15. The machine tool of claim 14, wherein the feed device is an electromagnetic feed device.

16. The machine tool of claim 14, wherein
a direction of movement of the main spindle along the axis of rotation depends on the force generated by the feed device, a torque generated by the drive, a resistance force acting along the axis of rotation, and a resistance torque, and
a tool received in the tool holder experiences the resistance force in the workpiece, and the tool experiences the resistance torque in the workpiece with respect to a rotation about the axis of rotation.

17. The machine tool of claim 14, wherein the first component has a sleeve comprising a wall, and wherein the wall has, on an inside of the wall, a helical recess that is delimited by two helical surfaces.

18. The machine tool of claim 17, wherein the cam has a radially projecting pin that engages in the helical recess.

19. The machine tool of claim 18, wherein the pin carries a roller engaging one of the two helical surfaces.

20. The machine tool of claim 17, wherein the second component comprises two cams projecting opposite each other from the main spindle in a radial direction.

21. The machine tool of claim 14, wherein the first component has a sleeve comprising a wall, and wherein the wall has a helical aperture that is delimited by two helical surfaces.

22. The machine tool of claim 21, wherein the cam has a radially projecting pin that engages in the helical aperture.

23. The machine tool of claim 22, wherein the pin carries a roller engaging one of the two helical surfaces.

24. The machine tool of claim 21, wherein the second component comprises two cams projecting opposite each other from the main spindle in a radial direction.

25. The machine tool of claim 14, wherein the feed device has a stator arranged fixed to the housing and has a rotor mounted so as to be axially movable along the axis of rotation and transferring axial movements to the main spindle.

26. The machine tool of claim 25, further comprising:
a workpiece holder;
a first electromagnet configured to position the rotor in an axial rest position; and
a second electromagnet arranged in the stator and configured to generate a feed force directed towards the workpiece holder.

27. The machine tool of claim 14, further comprising:
a control device configured to control the feed device in such a way that, at least in a period of time after the tool has penetrated the workpiece, the tool advances into the workpiece with a feed movement on which oscillations are superimposed.

28. A machine tool for machining a workpiece, the machine tool comprising:
a main spindle having an end that carries a tool holder, wherein the main spindle is mounted so as to be rotatable about an axis of rotation and movable along the axis of rotation;
a drive for driving the main spindle about the axis of rotation;
a feed device comprising a stator arranged fixed to the housing and a rotor mounted so as to be axially movable along the axis of rotation and transferring axial movements to the main spindle; and
a screw-and-nut gearing connecting the drive to the main spindle and configured to drive the main spindle in rotation and simultaneously move the main spindle along the axis of rotation,
wherein the screw-and-nut gearing comprises a thread formed on a first component and a cam formed on a second component and cooperating with the thread,
wherein one of the first component and the second component is rotatable by the drive via a drive gear and is immovably mounted along the axis of rotation, and
wherein the other one of the first component and the second component is the main spindle.

29. A method of machining workpieces, the method comprising the following steps:
providing a main spindle having an end that carries a tool holder into which a tool is inserted;
driving the main spindle by a drive so that the tool spindle rotates about an axis of rotation; and
exerting a force acting along the axis of rotation on the main spindle by a feed device,
wherein the main spindle is rotated by a screw-and-nut gearing, which connects the drive to the main spindle, and is simultaneously moved along the axis of rotation.

30. The method of claim 29, wherein
a direction of movement parallel to the axis of rotation depends on a force generated by the feed device, a torque generated by the drive, a resistance force acting along the axis of rotation, and a resistance torque, and
a tool received in the tool holder experiences the resistance force in the workpiece, and the tool experiences the resistance torque in the workpiece with respect to a rotation about the axis of rotation.
